(19) United States
(12) Patent Application Publication
(10) Pub. No.: US 2012/0129697 A1
(43) Pub. Date: May 24, 2012

(54) Plant Growth Enhancing Mixture and Method of Applying Same

(75) Inventors: Jerry Stoller, Houston, TX (US); Albert Liptay, Houston, TX (US); Ronald Salzman, College Station, TX (US)

(73) Assignee: STOLLER ENTERPRISES, INC.

(21) Appl. No.: 13/300,238

(22) Filed: Nov. 18, 2011

Related U.S. Application Data
(60) Provisional application No. 61/415,675, filed on Nov. 19, 2010.

(51) Int. Cl. A01N 43/90; A01P 21/00

(52) U.S. Cl. 504/136

(57) ABSTRACT

Plant growth enhancing mixture and method of selectively timing the application of same during the development of crop plants or other plants to positively augment cell number increase and cellular development of crop plants or other plants to enhance development and/or productivity of the economic portion of the crop plant or other plant. Application of the plant growth enhancing mixture at flowering enhances both weak flowers and normally strong flowers. The plant growth enhancing mixture and method of application have also been shown to impart varying disease resistance to the treated crop or other plants. The plant growth enhancing mixture and method of application also increases the depth and strength of rooting for greater access and transport of water and nutrients for growth and productivity of the crop plant.

### CROSS REFERENCE TO RELATED APPLICATION

This application is based upon provisional application 61/415,675, filed on 11/19/10, the priority of which is claimed.

### BACKGROUND OF THE INVENTION

1. Field of the Invention

This invention relates generally to a plant growth enhancing mixture and its methods of application to plant tissues to increase plant growth and productivity. Specifically, the invention relates to a combination of plant hormones or other molecules, which when optionally applied together with various minerals including nitrogen, produces an unexpected enhancement of the growth and development of plant tissues, including but not limited to vegetative, floral, seed, and fruiting tissues.

2. Description of the Related Art

Plant growth and development as well as productivity (e.g., crops, seeds, fruits etc.) are known to be regulated by growth factors, mineral components and small molecules that signal for the expression of genes that enhance the level of plant productivity, whether in quantity or quality. Traditional approaches for improving plant productivity have included the application of various minerals and nitrogen components as necessary additions or substrates to crop plant or other plant productivity. However, such approaches have tended to knowingly, or unknowingly, disregard the growth factors (e.g., hormones and/or other small molecules) required for enhanced productivity.

More recent approaches for improving plant productivity have included genetic engineering techniques, such as manipulating genes not pre-disposed to affect certain targeted responses deemed to enhance productivity and/or adding other genes that better express the desired plant characteristics. While these transgenic approaches certainly have their advantages (e.g., disease/insect resistance, herbicide resistance, larger crops/fruits, etc.), they have also been met with much public resistance as being unsafe, unnatural and possibly harmful to the environment.

An alternative, more natural approach, which is becoming ever more appreciated, is based upon the theory that plants already have the necessary genes/genetic code to produce greater quantities and/or qualities of various plant tissues as well as to thrive in the face of common adversities, such as drought, disease, and insect infestations. But, to realize the full expression of this innate genetic material and the plant's full potential, the plant must receive various naturally-occurring nutrients and/or hormones in specific concentrations, at specific times during the plant's growth, and to specific parts or tissues of the plant. U.S. Pat. No. 6,040,273, incorporated by reference, and U.S. Patent Application Publications 2005/0043177 and 2005/0197253 provide some examples of work in this area. Considering the sheer amount of research into techniques and compositions to improve food production as well as the continual need for greater food production to feed an exponential human population growth, there is a long felt and unfulfilled need for improved methods and compositions to improve plant productivities.

3. Identification of Objects of the Invention

An object of the invention is to accomplish one or more of the following:

Provide a chemical composition or mixture that stimulates plant growth and productivity;

Provide a chemical composition or mixture that facilitates and/or increases nitrogen utilization by plants;

Provide a mixture or combination of one or more plant hormones, one or more minerals, and nitrogen compounds that enhance the growth of crop and other plants.

Provide a method of applying a chemical mixture and/or combination comprising one or more plant hormones, one or more minerals, and nitrogen compounds that enhances the growth of plant tissues;

Provide a chemical composition and method of applying same that enhances the disease resistance of plants, the pest tolerance of plants or the innate immunity of plants; and

Provide a chemical composition and method of applying same that enhances the economic or other portion of plants by increasing the strength of weak and strong flowers.

Other objects, features, and advantages of the invention will be apparent to one skilled in the art from the following specification and drawings.

### SUMMARY OF THE INVENTION

The objects identified above, along with other features and advantages of the invention are incorporated in a plant growth enhancing mixture comprising a combination of at least the plant hormones, cytokinin and gibberellin. The plant growth enhancing mixture may also include various minerals including one or more of zinc, calcium, boron, potassium and nitrogen. While the plant growth enhancing mixture may include these minerals, such minerals are preferably not pre-mixed with the plant hormones due to the possibility of chemical precipitation. Instead, the plant hormones and the minerals are preferably applied concurrently, or at different times, to the plants and/or to the soil in which the plants are growing.

The plant growth enhancing mixture has been observed to increase the extent of cellular division and development of the vegetative, floral, seed, fruiting or other tissues of plants, when applied to the root system of the plants in whatever growing medium that the plants are being propagated, grown or produced. Several examples are provided which demonstrate the statistically significant increase in plant growth due to the application of preferred implementations of the plant growth enhancing mixture.

Application of the plant growth enhancing mixture has also been unexpectedly determined to impart disease and insect resistance not before seen in crop and other plants. Several examples demonstrate the efficacy of the plant growth enhancing mixture to inhibit various plant diseases, including but not limited to, Sudden Death Syndrome, potato zebra chip, tomato leaf curl virus and Phytophthora. The plant growth enhancing mixture has also been shown to strengthen both weak flowers and normally strong flowers when applied to the plants during flowering.

### BRIEF DESCRIPTION OF THE DRAWINGS

By way of illustration and not limitation, the invention is described in detail hereinafter on the basis of the accompanying figures, in which:

FIG. 1 is a black and white photograph illustrating, after four weeks, the comparative results of applying the plant growth enhancing mixture of a preferred implementation to growing tomato plants;

FIG. 2 is a black and white photograph illustrating the comparative results of applying plant growth enhancing mixtures having varying amounts of nitrogen to soybean plants;

FIG. 3 is a black and white photograph illustrating the comparative results of applying the plant growth enhancing mixture of a preferred implementation to soybean plants infected with Sudden Death Syndrome (SDS); and

FIG. 4 is a black and white photograph illustrating the comparative results of applying the plant growth enhancing mixture of a preferred implementation to tomato plants infected the with tomato leaf curl virus.

FIG. 5 is a black and white photograph illustrating the comparative results to the growth of corn plant roots of applying the plant growth enhancing mixture of a preferred implementation of the present invention;

FIG. 6 is a black and white photograph illustrating roots of an untreated corn plant, including the radicle roots;

FIG. 7 is a black and white photograph illustrating roots of a corn plant that has been treated with the plant growth enhancing mixture of a preferred implementation, including the radicle roots and the mesocotyl;

FIG. 8 is a black and white photograph illustrating the comparative results of applying the plant growth enhancing mixture of a preferred implementation to tomato plants.

### DESCRIPTION OF THE PREFERRED IMPLEMENTATIONS OF THE INVENTION

A preferred implementation of the invention addresses one or more of the deficiencies of the prior art and incorporates at least one of the objects previously identified. The invention employs a plant growth enhancing mixture comprising a specific combination/composition of chemical components and/or timing of their application to growing plants that enhance the extent of cellular division and development of vegetative, floral, seed, fruiting or other tissues of crop plants or other plants when applied together and/or at specific times to the roots of the plants. Such enhancement may take the form of an increase in the number and types of cells and/or cellular components and/or the quality of the plant tissues as measured by tissue integrity, tissue color, tissue desirability in taste, if consumed, and including all facets of taste, biochemical components, tissue plasticity (or lack of same), tissue strength or other physical component or attributes. The plants referred to herein include any and all crop plants (referring to human or other biological organism consumption or industrial consumption) or ornamental and/or other plants that produce tissues that are desirable including, but not limited to, the leaves, parts of leaves or other tissues of the plants or flowers or seeds for use of the whole tissue or biochemical or physical components of the plant tissue.

In a preferred implementation, the plant growth enhancing mixture comprises an aqueous blend of two plant hormones—cytokinin and gibberellin. As is well known to those skilled in the art, cytokinin and gibberellin may be obtained from various natural sources or they may be chemically synthesized. The gibberellin is preferably selected from one or more of the following: GA₁, GA₂, GA₃, GA₄, GA₅, GA₆, GA₇, GA₈, GA₉, GA₁₀, GA₁₁, GA₁₂, GA₁₃, GA₁₄, GA₁₅, GA₁₆, GA₁₇, GA₁₈, GA₁₉, GA₂₀, GA₂₁, GA₂₂, GA₂₃, GA₂₄, GA₂₅, GA₂₆, GA₂₇, GA₂₈, GA₂₉, GA₃₀, GA₃₁, GA₃₂, GA₃₃, GA₃₄, GA₃₅, GA₃₆, GA₃₇, GA₃₈, GA₃₉, GA₄₀, GA₄₁, GA₄₂, GA₄₃, GA₄₄, GA₄₅, GA₄₆, GA₄₇, GA₄₈, GA₄₉, GA₅₀, GA₅₁, GA₅₂, GA₅₃, GA₅₄, GA₅₅, GA₅₆, GA₅₇, GA₅₈, GA₅₉, GA₆₀, GA₆₁, GA₆₂, GA₆₃, GA₆₄, GA₆₅, GA₆₆, GA₆₇, GA₆₈, GA₆₉, GA₇₀, GA₇₁, GA₇₂, GA₇₃, GA₇₄, GA₇₅, GA₇₆, GA₇₇, GA₇₈, GA₇₉, GA₈₀, GA₈₁, GA₈₂, GA₈₃, GA₈₄, GA₈₅, GA₈₆, GA₈₇, GA₈₈, GA₈₉, GA₉₀, GA₉₁, GA₉₂, GA₉₃, GA₉₄, GA₉₅, GA₉₆, GA₉₇, GA₉₈, GA₉₉, GA₁₀₀, GA₁₀₁, GA₁₀₂, GA₁₀₃, GA₁₀₄, GA₁₀₅, GA₁₀₆, GA₁₀₇, GA₁₀₈, GA₁₀₉, GA₁₁₀, GA₁₁₁, GA₁₁₂, GA₁₁₃, GA₁₁₄, GA₁₁₅, GA₁₁₆, GA₁₁₇, GA₁₁₈, GA₁₁₉, GA₁₂₀, GA₁₂₁, GA₁₂₂, GA₁₂₃, GA₁₂₄, GA₁₂₅, GA₁₂₆. The cytokinin is selected from one or more of the following: zeatin, various forms of zeatin, N6-benzyl adenine, N6-(delta-2-isopentyl) adenine, 1,3-diphenyl urea, thidiazuron, CPPU (forchlorfenuron), kinetin or other chemical formulations with cytokinin activity.

The preferred gibberellin is the gibberellic acid, GA₃, and is present in the aqueous mixture in an amount such that the GA₃ is between about 0.1 to 10 percent by weight, more preferably between about 0.5 to about 5 percent by weight and most preferably between about 0.075 to about 0.125 percent by weight. The preferred cytokinin is kinetin and is present in the aqueous mixture in an amount such that the kinetin is between about 0.003 to 0.3 percent by weight, more preferably between about 0.0015 to 0.15 percent by weight and most preferably between about 0.01 to 0.05 percent by weight.

The ratio of the plant hormones, cytokinin and gibberellin, preferably ranges from 1:10 to 1:300 and more preferably from 1:20 to 1:40. A ratio of approximately 1:30 is most preferable. Nonetheless, to obtain the best results, the absolute amount of the cytokinins and gibberellins must vary proportionally to the volume/weight of the treated plants and their fruit. The absolute amount of the cytokinins preferably varies between 1 to 300 mg per hectare of growing plants, but more preferably between 20 to 80 mg per hectare of growing plants. The absolute amount of the gibberellins preferably varies between 100 to 10,000 mg per hectare of growing plants, but more preferably between 500 to 2,500 mg per hectare of growing plants.

The plant growth enhancing mixture optionally, but preferably, includes one or more minerals that assist in the uptake of the plant hormones by plant tissues and/or compliment the utilization of the plant hormones by the plant tissues. Preferred minerals include zinc, nitrogen, potassium, calcium and boron, with nitrogen, potassium, calcium and/or boron being the most preferred. The preferred application rate of calcium and boron is 10 to 100 pounds calcium per acre and ¼th to 2 pounds boron per acre. The minerals including nitrogen are preferably not pre-mixed with the plant hormones, at least not for an extended period of time, due to the risk of chemical precipitation. Instead, the minerals, if any, are preferably applied concurrently with the plant hormones (e.g., by mixing the minerals and plant hormones at or just prior to application). Alternatively, any minerals may be applied prior to, or subsequently to, the application of the plant hormones. For convenience, the above quantities of plant hormones and minerals are given in terms of planted acres or hectares, however, the plant growth enhancing mixture is further envisioned to be applied to plant roots through alternative growing media, including but not limited to, hydroponics and aeroponics.

Typically, soybean plants require approximately five pounds of nitrogen per bushel of harvested soybeans. Of this quantity, about three pounds of nitrogen are created through the action of nitrogen-fixing bacteria at or near the roots and about two pounds of nitrogen are obtained from the soil in which the roots of the soybeans are growing. Others types of crop plants have similar, typical nitrogen utilizations. However, when the above-described plant hormones and/or minerals are applied to the soils/roots of growing plants, it has been discovered that the plants utilize and are able to utilize far greater amounts of nitrogen from the soil than would normally occur. This is an unexpected result, because such large amounts of nitrogen fertilization typically damage plant roots and/or are detrimental to plant health. The plant growth enhancing mixture, comprising cytokinin and gibberellin, may also stimulate nitrogen-fixing bacteria in the vicinity of the plant roots to continue fixing nitrogen from the air into the soil for a greater period of time than would normally occur.

The nitrogen used in a preferred implementation of the plant growth enhancing mixture is preferably a liquid nitrogen fertilizer comprising approximately one-half urea and one-half ammonium nitrate. Such a liquid nitrogen fertilizer has a nitrogen content of about 28 to 32 percent and is preferably injected into the soil of the plants to a depth of between two to four inches. The total amount of liquid nitrogen fertilizer applied to the plants is preferably between 50 and 400 pounds of nitrogen per acre (i.e., 56.0 to 448.3 kg per hectare), more preferably between 100 and 300 pounds of nitrogen per acre (i.e., 112.1 to 336.3 kg per hectare) and most preferably at about 200 lbs. nitrogen per acre (i.e., 224.2 kg per hectare). This total amount of liquid nitrogen fertilizer may be applied in a single application, as further described below, or may be split into one or more applications. Additional types of liquid nitrogen fertilizers, such as anhydrous ammonia, aqua ammonia and low-pressure 41% nitrogen solutions, may also be employed as the nitrogen source, however, these additional types of liquid nitrogen fertilizers must be injected into the ground to avoid an atmospheric loss of gaseous ammonia (i.e., nitrogen).

The optimal amount of applied nitrogen is dependent on a number of factors with the most important being the type of plant. The application of approximately 200 lbs. of nitrogen per planted acre (i.e., 224.2 kg/hectare) has shown favorable results for soybeans. Moreover, in a preferred implementation of the invention, the best corn growth has been realized with a greater nitrogen application of about 400 lbs. of nitrogen per planted acre (i.e., 448.3 kg/hectare). The liquid nitrogen fertilizer is applied at the same time as the plant hormones and other minerals, if any, or at a later time before flowering. Preferably, the liquid nitrogen fertilizer is blended with the plant hormones and other minerals, if any, just prior to application, such that only a single field application of the homogenous mixture/combination is needed, thereby reducing labor and equipment costs that would otherwise be required due to a later nitrogen-only field application. While a single application of the plant growth enhancing mixture containing the liquid nitrogen fertilizer has been shown to provide good results for single harvest crops, an additional application of liquid nitrogen fertilizer after each of one or more harvests in multiple harvest crops (e.g., tomatoes), has been shown to be beneficial, at least in some crop plants. While the use of a liquid nitrogen fertilizer is described above, a granular nitrogen fertilizer may alternatively be employed. However, the solid nitrogen fertilizer may need to be applied to the soil of the growing plants in a separate step from the application of the plurality of plant hormones and any other minerals.

In a preferred method of the invention, the plant growth enhancing mixture is readied and applied to the roots of growing plants, or via the soil in which the plants are growing, through drip irrigation. Other fertigation-type application methods that may be employed include, but are not limited to, broadcasting (e.g. conventional irrigation) and other types of placement application (e.g. side dressing; microjets, etc.). Broadcast application is an acceptable method, if sufficient irrigation is permitted to wash the plant growth enhancing mixture from the foliage and above-ground tissues of the plants and into the soil/roots. The plant growth enhancing mixture is preferably applied after the plants have approximately 4 to 6 leaves. There are only a few exceptions wherein the plant growth enhancing mixture may be applied to seeds or seedlings. One such exception is to wheat crops and another is to epiphyte-like plants such as pineapples. The plant growth enhancing mixture is applied to the soil/roots preferably just before or during the reproductive stage (i.e., flowering) of plant development (i.e., between the seedling and flowering stages of plant development). Soil/root application of the plant growth enhancing mixture after flowering has been found to be less effective and may even have a deleterious effect, as further explained below. Similarly, soil/root application prior to the plant having a plurality of leaves or within 7 to 14 days of transplantation is to be generally avoided.

The plant growth enhancing mixture (without minerals) is preferably applied to the soil/roots at the rate of 0.1 to 10 pints per acre (i.e., 0.117 to 1.17 liters/hectare). Additional types of plant treatments may be beneficial and produce synergistic effects when used in conjunction with the methods and compositions described herein. For example, plant treatment using a preferred composition of U.S. Pat. No. 6,040,273, issued to Dean, during the seedling stage may further improve the results realized through subsequent application of the plant growth enhancing mixture containing the liquid nitrogen fertilizer.

The plant growth enhancing mixture comprising the plant hormones, cytokinin and gibberellin and minerals, but without liquid nitrogen fertilizer, is organic. The preferred liquid nitrogen fertilizer, however, is non-organic. Nevertheless, organic sources of nitrogen may be used in order to qualify the entire treatment as organic, environmentally green, and/or sustainable. Such organic nitrogen sources include, but are not limited to, animal manure, urine and feathers.

Preferred implementations of the invention are further described in the following several examples. However, these examples are not meant in any way, and should not be interpreted, to limit the scope of the invention disclosed herein.

### Example 1

In this example, the effect of the plant growth enhancing mixture on the growth of field-planted soybeans was studied. The cultivar of soybean planted was Vernal. These soybeans were sown Jun. 1, 2009, in a Weslaco, Tex. field prepared according to state recommended fertilization practices for planting soybeans. A plant growth enhancing mixture of a preferred implementation was applied to soil in which the field-planted soybeans were growing at the reproductive (i.e., R2) stage of growth. This plant growth enhancing mixture had kinetin as the cytokinin at 0.03% and GA₃ as the gibberellic acid (i.e., gibberellin) at 1.0%. The plant growth enhancing mixture (without minerals) was dispersed through drip irrigation at the rate of 2 pts/acre. Liquid nitrogen fertilizer (i.e., 50% urea and 50% ammonium nitrate) was applied through the drip irrigation system in three applications of 30 lbs. per acre of nitrogen each (i.e., 33.6 kg/hectare) for a total application of 90 lbs. per acre (i.e., 100.9 kg/hectare). The 30 lbs. per acre (i.e., 33.6 kg/hectare) nitrogen fertilizer applications were applied at four weeks after sowing, six weeks after sowing and eight weeks after sowing. The plant growth enhancing mixture included the last nitrogen application at eight weeks after sowing. The soybeans were harvested on Oct. 22, 2009.

The soybean yields for four replicates of an untreated, control, normally-managed soybean plot and four replicates of a soybean plot treated according to the above description were determined. The soybean yields for the four control replicates were 83.8 bushels per acre, 97.3 bushels per acre, 97.8 bushels per acre and 90.8 bushels per acre. The average soybean yield for the four control plots was 92.4 bushels per acre with a standard deviation of 6.6 bushels per acre. The soybean yields for the four plant growth enhancing mixture treated replicates were 171.8 bushels per acre, 164.8 bushels per acre, 160.6 bushels per acre and 170.1 bushels per acre. The average soybean yield for the four treated plots was 166.8 bushels per acre with a standard deviation of 5.1 bushels per acre. The statistical “t test” for significant difference between the average yields of the control and the treated plots was p=0.0005, indicative of a highly significant difference.

### Example 2

In this example, the preferred implementation of the cytokinin and gibberellin of the plant growth enhancing mixture of Example 1 were applied via drip irrigation to Spanish onions. The plant growth enhancing mixture (without minerals) was applied at a rate of 3 pts per acre into the soil in which the Spanish onions had been transplanted in Ethiopia, Wash. on Mar. 3, 2010. In addition to the state recommended soil preparation (i.e., fertilization) for the transplantation of onion plants, the plant growth enhancing mixture included a nitrogen side dressing that was applied to the soil at a rate of 10 lbs. nitrogen per acre at 10 weeks, 12 weeks and 14 weeks after transplantation of the onion plants. The Spanish onions were harvested on Jul. 29, 2010. The four replicate experiments yield a total of 39,498 lbs. of onions (Duncan's p=0.05 New Multiple Range Test) while the four replicate control experiments yielded a total of 21,725 lbs. of onions. Thus, the treated onions had an 81.8% increase in yield over the untreated (control) onions. It should be noted that the increase in yield of the onions was not an increase in the number of onions but in the increased size of the onions.

### Example 3

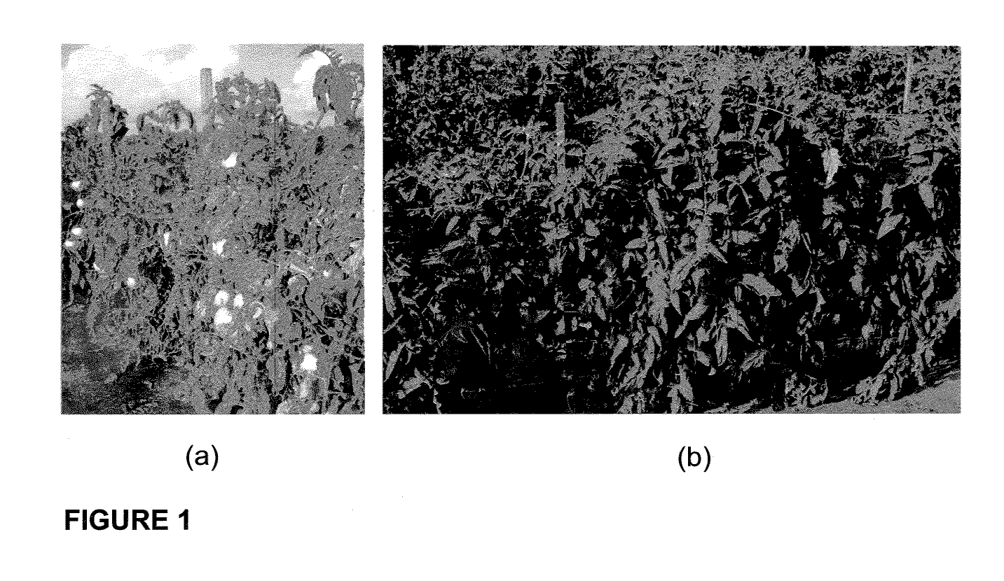

In this example, the effect of the plant growth enhancing mixture treatment on tomato plants was studied. As shown in FIG. 1, the tomato plant (a) on the left was not treated with the cytokinin and gibberellin of the plant growth enhancing mixture of Example 1 while the tomato plant (b) on the right is shown at four weeks after such treatment. As is readily evident to one of ordinary skill in the art, the treated tomato plant (b) is much greener (i.e., darker), healthier and better developed, and has more tomatoes, than the untreated tomato plant (a).

### Example 4

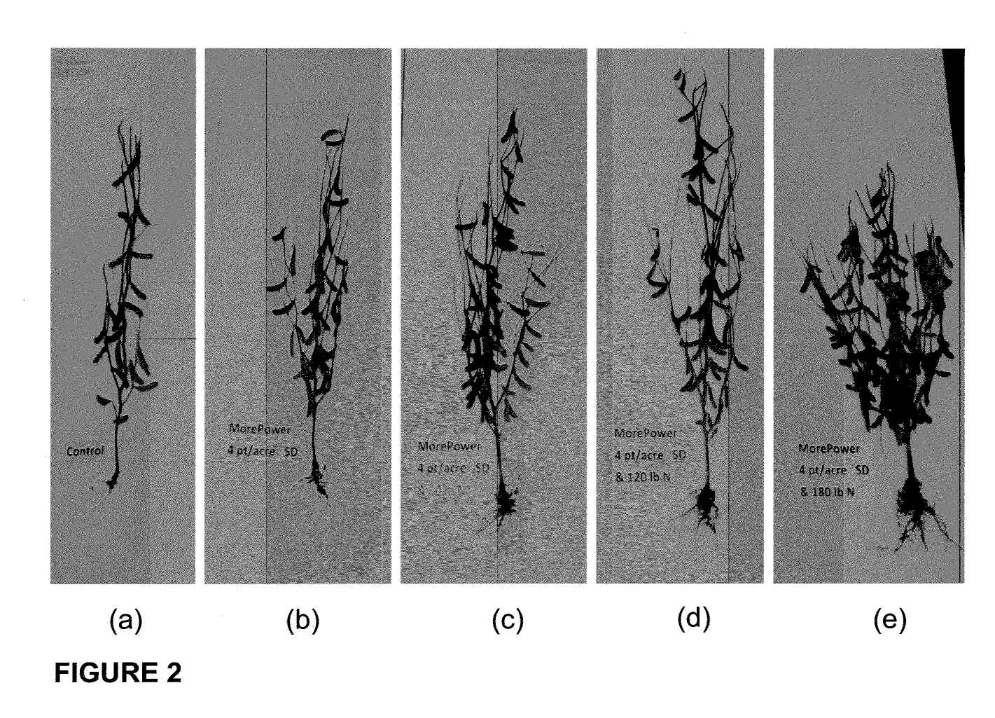

In this example, the effect of the cytokinin and gibberellin of the plant growth enhancing mixture of Example 1 together with varying amounts of applied nitrogen on the growth of field-planted soybeans was studied. As shown in FIG. 2, the control plant labeled (a) did not receive any application of the plant growth enhancing mixture (and no additional nitrogen beyond the state recommended fertilization in conjunction with soil preparation for planting). The plants labeled (b) through (e) received an application of the plant growth enhancing mixture (without minerals) at a rate of 4 pints per acre together with varying amounts of additional nitrogen, as follows: plant (b) received no added nitrogen, plant (c) received 60 pounds of nitrogen per acre, plant (d) received 120 pounds of nitrogen per acre and plant (e) received 180 pounds of nitrogen per acre. As can readily be seen from FIG. 2, the plant (e) which received the application of the plant growth enhancing mixture together with the highest amount of nitrogen (e.g., 180 lbs./acre) also showed the most cellular growth, and particularly, the greatest development of soybeans. The plant (e) has at least a 30% increase in soybean yield over the control plant (a).

Another feature of the invention is that the application of the plant growth enhancing mixture (with or without liquid nitrogen fertilizer) to plants using one or more of the previously described method(s) unexpectedly appears to suppress a variety of plant diseases and to promote insect resistance.

### Example 5

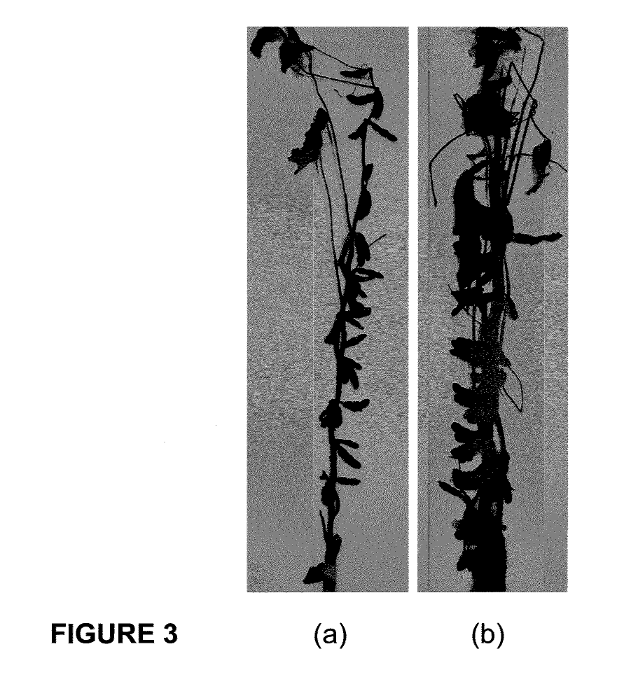

In this example, the effect of the plant growth enhancing mixture on soybean plants under attack from severe Sudden Death Syndrome (SDS) was studied. For this example, the plant growth enhancing mixture consisted of 2 pts/acre of 0.03% cytokinin and 1.0% gibberellin as well as 100 lbs. nitrogen and 100 lbs. potassium per acre. As shown in FIG. 3, the harvested plant (a) on the left had SDS but was not treated with the plant growth enhancing mixture (with minerals). However, the harvested plant (b) on the right was treated with the plant growth enhancing mixture (with minerals). The photograph of plant (b) shows that, even while suffering the complications of SDS, the plant growth enhancing mixture facilitates the plant's growth and crop development. The SDS does not appear to have decreased nitrogen utilization in the treated plant whereas the SDS has take a significant toll on the growth and crop development of the untreated plant. It should be noted that both plants (a) and (b) were planted in soil fertilized according to state recommended practices.

### Example 6

In this example, the effect of the plant growth enhancing mixture on soybean plants under attack from severe SDS was observed. The cultivar of the soybeans planted was Asgrow 2403 and the soybeans were sown in an Ames, Iowa field, which had been prepared for planting using the state recommended fertilization practices. The soybeans were planted on Apr. 29, 2010 and harvested on Oct. 3, 2010. As shown in the Table, eight different experiments were conducted involving eight replicates per experiment. The treated plants showing the most enhancement were those of experiment six, which saw a 62% growth rate over the control plants of experiment one.

A plant growth enhancing mixture of a preferred implementation was applied to soil in which the field-planted soybeans were growing at the reproductive stage of growth (R2). This plant growth enhancing mixture had kinetin as the cytokinin at 0.03% and GA₃ as the gibberellic acid (i.e., gibberellin) at 1.0%. While the soil was fertilized according to state recommended practices prior to planting, the plant growth enhancing mixture also included additional liquid nitrogen fertilizer (i.e., 50% urea and 50% ammonium nitrate), which was applied through a drip irrigation system in the amounts provided in the accompanying Table.

The soybean yields were determined for an untreated, control, normally-managed diseased soybean plot (experiment one) and for seven additional soybean plots (experiments two through eight) treated with various amounts of the plant growth enhancing mixture. As shown in the Table, each experiment consisted of eight replicates. The plots used in these experiments had an area of 25 square feet. The soybean yields for the eight typical, diseased control replicates were 8.39 bushels per acre, 9.6 bushels per acre, 13.9 bushels per acre, 19.7 bushels per acre, 9.6 bushels per acre, 13.6 bushels per acre, 25.2 bushels per acre and 18.5 bushels per acre. The average soybean yield for the eight control plots was 14.8 bushels per acre with a standard deviation of 5.9 bushels per acre.

The soybean yields for the eight plant growth enhancing mixture treated replicates at a dose rate of 2 pt per acre, were 12.2 bushels per acre, 22 bushels per acre, 23.4 bushels per acre, 32.1 bushels per acre, 14.5 bushels per acre, 15.9 bushels per acre, 24 bushels per acre and 21.7 bushels per acre. The average soybean yield for the eight treated plots at a dose of 2 pt per acre was 20.8 bushels per acre with a standard deviation of 6.4 bushels per acre. The statistical “t test” for significant difference between the average yields of the control and the treated plots was p=0.006, indicative of a highly significant difference.

The soybean yields for the eight plant growth enhancing mixture treated replicates at a dose rate of 4 pt per acre, were 11 bushels per acre, 25.2 bushels per acre, 31 bushels per acre, 23.2 bushels per acre, 21.2 bushels per acre, 25.2 bushels per acre, 32.7 bushels per acre and 22.3 bushels per acre. The average soybean yield for the eight treated plots at a dose of 4 pt per acre was 24 bushels per acre with a standard deviation of 6.6 bushels per acre. The statistical “t test” for significant difference between the average yields of the control and the treated plots was p=0.003, indicative of a highly significant difference.

The soybean yields for the eight plant growth enhancing mixture treated replicates at a dose rate of 8 pt per acre, were 17.7 bushels per acre, 24 bushels per acre, 18.5 bushels per acre, 10.1 bushels per acre, 23.2 bushels per acre, 16.2 bushels per acre, 16.2 bushels per acre and 24.9 bushels per acre. The average soybean yield for the eight treated plots at a dose of 8 pt per acre was 18.9 bushels per acre with a standard deviation of 5.0 bushels per acre. The statistical “t test” for significant difference between the average yields of the control and the treated plots was p=0.13, indicative of a non-significant difference.

The soybean yields for the eight fertilizer-only treated replicates at a dose rate of 100 lb. of nitrogen and 100 lb. of potassium per acre, were 23.4 bushels per acre, 26 bushels per acre, 28.7 bushels per acre, 15.3 bushels per acre, 8.1 bushels per acre, 15.3 bushels per acre, 28.9 bushels per acre and 22.9 bushels per acre. The average soybean yield for the eight fertilizer-only treated plots was 21.1 bushels per acre with a standard deviation of 7.4 bushels per acre. The statistical “t test” for significant difference between the average yields of the control and the treated plots was p=0.03, indicative of a significant difference at the 5% level.

Experiments conducted in disease-ridden soybean plots (i.e., for the purposes of indicating whether the treatments can suppress the effect of the disease) very often show a high level of variability among replicate plots. Therefore, a larger number of replicates—8 replicates versus the more normal 4 replicates per treatment—becomes necessary. As demonstrated in this example, the dose rate of 2 pt per acre of the plant hormones of the plant growth enhancing mixture, along with the nitrogen/potassium fertilizer included in the mixture, yielded a suboptimal 20.8 bushels per acre even though this yield was 40.5% over the control untreated plot. At the dose rate of 4 pt per acre, the yield was the largest of the replicates at 24 bushels per acre with a 62.2% increase in yield over the control plots. At the highest dose rate of 8 pt per acre, the yield was 21.2 bushels per acre with a 42.6% increase in yield over the control plots. Thus, the highest dose rate of the plant hormones in the plant growth enhancing mixture is too high for optimal yields.

TABLE

| | Diff. | Ave | Ave | “t” test | REP | REP | REP | REP | REP | REP | REP | REP |
|---|---|---|---|---|---|---|---|---|---|---|---|---|
| | from | g | bushels | vs. | 1 | 2 | 3 | 4 | 5 | 6 | 7 | 8 |
| | control | per | per | control | g per | g per | g per | g per | g per | g per | g per | g per |
| Exp. | % | plot | acre | p= | plot | plot | plot | plot | plot | plot | plot | plot |
| 1 | n/a | 231.9 | 14.8 | n/a | 132 | 150 | 218 | 308 | 150 | 213 | 395 | 290 |
| 2 | 41 | 327.7 | 20.9 | 0.00087 | 263 | 363 | 386 | 444 | 240 | 290 | 336 | 299 |
| 3 | 28 | 296.6 | 18.9 | 0.14449 | 367 | 299 | 526 | 322 | 99.8 | 268 | 213 | 278 |
| 4 | −21 | 182.0 | 11.7 | n/a | 109 | 159 | 218 | 127 | 145 | 99.8 | 190 | 408 |
| 5 | 41 | 324.9 | 20.8 | 0.00603 | 190 | 345 | 367 | 504 | 227 | 250 | 376 | 340 |
| 6 | 62 | 375.4 | 24.0 | 0.00270 | 172 | 395 | 485 | 513 | 363 | 331 | 395 | 349 |
| 7 | 28 | 295.4 | 18.9 | 0.12581 | 277 | 376 | 290 | 159 | 363 | 254 | 254 | 390 |
| 8 | 43 | 330.6 | 21.1 | 0.03164 | 367 | 408 | 449 | 240 | 127 | 240 | 454 | 358 |

Experiments:
1. Control (state recommended fertilization practices).
2. Seed treatment, A at 4 ounces per cwt of seed.
3. Seed treatment, A at 8 ounces per cwt of seed.
4. Seed treatment, C at 6 ounces per cwt of seed.
5. [In furrow A at 1 pt; before flowering side dressing C at 2 pt, 100 lbs. N and 100 lbs. K]/acre.
6. [In furrow A at 1 pt; before flowering side dressing C at 4 pt, 100 lbs. N and 100 lbs. K]/acre.
7. [In furrow A at 1 pt; before flowering side dressing C at 8 pt, 100 lbs. N and 100 lbs. K]/acre.
8. Control and side dressing of [100 lbs. N and 100 lbs. K]/acre.
A = A preferred implementation of the composition of U.S. Pat. No. 6,040,273;
C = The plant growth enhancing mixture of Example 1.

### Example 7

Zebra chip, or papa rayada, is a devastating disease in many parts of the United States that adversely affects potatoes. Zebra chip takes its name from the black colored stripes that are often found in potato chips produced from potatoes affected by the disease. In this example, the effect of the plant growth enhancing mixture on potato plants under attack from zebra chip was observed. The cultivar was Frito Lay® 1875 potatoes. These potatoes were planted in Weslaco, Tex. on Jan. 5, 2010 and harvested on Apr. 27, 2010. The recommended state fertilization practices were applied to a control plot of the planted potatoes (i.e., 100 lbs. nitrogen per acre).

To the remaining planted potatoes, the cytokinin and gibberellin of the plant growth enhancing mixture of Example 6 were applied to the soil at the rate of 1 pint per acre in which the potatoes were growing. The potatoes treated with this plant growth enhancing mixture did not receive any additional nitrogen fertilizer as compared to the potatoes of the control plot (i.e., the plant growth enhancing mixture did not contain any nitrogen application). Furthermore, the plant growth enhancing mixture applied to the potato plants of this example did not include any other minerals, such as calcium, boron or zinc. At harvest, the control potatoes yielded a paltry 47 bags per acre (i.e., 47,000 lbs./acre at 100 lbs. per bag) and 59% of the potato chips produced from these control potatoes had indications of zebra chip. Conversely, the treated potatoes yielded 197 bags per acre (i.e., 197,000 lbs./acre) and only 15% of the potato chips produced from the treated potatoes had indications of zebra chip. These differences between the control and treated potatoes are highly significant from a statistical point of view (i.e., p<0.01).

### Example 8

In this example, the ability of the plant growth enhancing mixture to suppress Phytophthora in peppers was studied. Phytophthora has proven to be a very difficult fungus to suppress in several crop plants. The cultivar used in this study was Tomcat, a cultivar particularly susceptible to Phytophthora, was transplanted on Jun. 16, 2010, in Bridgeton, N.J. The peppers were harvested on August 17th, September 9th and October 8th of 2010.

The plant growth enhancing mixture of a preferred implementation consisted of the plant hormones as described in Example 6, the minerals calcium and boron (½ pt/acre of 6.5% calcium solution; 1 pt/acre of 9% boron solution) and a sufficient amount of nitrogen fertilizer compounds to apply 100 lbs. of nitrogen per acre. The plant hormones of the plant growth enhancing mixture were applied to the soil in which the transplanted peppers were growing at a dose rate of 1 pt/acre. The replicate with the greatest infection of Phytophthora experienced a 29% increased yield of peppers over the yield obtained from the control plots grown using state recommended fertilization practices. Furthermore, the weekly rate of increased disease (i.e., killed plants) was significantly higher in the control pepper plants at 11.3% versus 2.5% for the plants treated with the growth enhancing mixture. In other words, after a four weeks, 45.2% (i.e., 11.3%×4) of the control plants had been killed by phythophthora while only 10% (i.e., 2.5%×4) of the treated plants had been killed. The plant growth enhancing mixture's ability to effectively suppress phythophthora disease is unexpected and is believed to be more effective than other commonly used fungicidal methods or compositions.

### Example 9

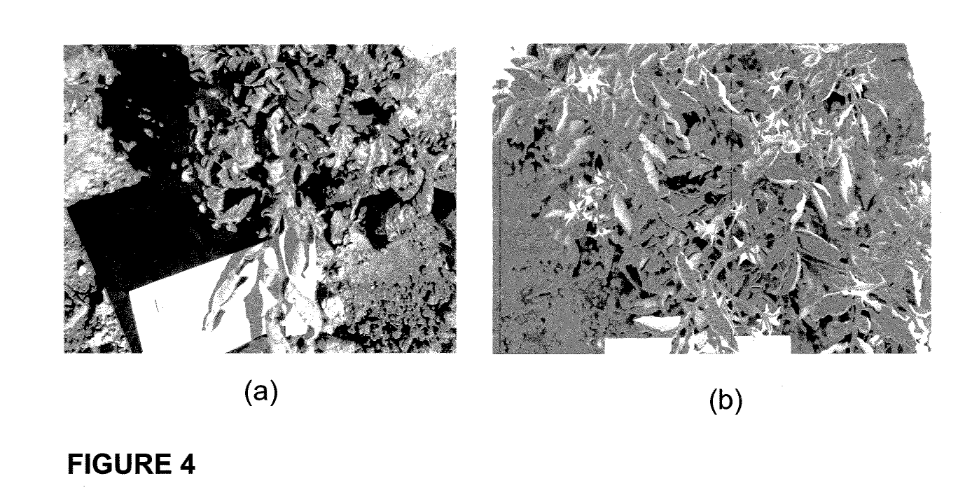

In this example, the effect of the plant growth enhancing mixture on tomato plants infected by tomato leaf curl virus was studied in a south Texas field. The leaves of tomato plant (a), shown on the left side of FIG. 4, are severely distorted by tomato leaf curl virus. The cytokinin and gibberellin of the plant growth enhancing mixture of Example 6 were applied to the soil in which these tomato plants, infected by tomato leaf curl virus, were growing. The cytokinin and gibberellin were applied on Oct. 31, 2010, at the rate of 10 pts/acre. The plant growth enhancing mixture also included the minerals, calcium, boron and nitrogen, which were concurrently applied. A solution of 5% calcium at the rate of 1 pt/acre and a solution of boron at the rate of 3 pts/acre. Nitrogen was applied by side dressing at the rate of 200 lbs. nitrogen per acre. The tomato plant (b) shown on the right side of FIG. 4 was photographed on Nov. 5, 2010, and shows the effect of the plant growth enhancing mixture on the diseased tomato plants just five days after treatment. One of ordinary skill in the art can readily recognize the rapid improvement in plant health after a single treatment. Such improvement is unexpected and has not been previously shown. Furthermore, gene expression studies were also conducted during the five day treatment period. The plant innate immunity genes, PR-1 and PR-5, were shown to be greatly up-regulated as a result of the specified plant growth enhancing mixture treatment.

### Example 10

Another feature of the invention is that the plant growth enhancing mixture may be used to strengthen both weak and strong flowers. As mentioned above, the plant growth enhancing mixture is normally not applied to the foliage, flowers, and/or soil or roots of a plant after the start of the reproductive stage of the plant development (i.e., during flowering). However, the plant growth enhancing mixture may be applied to flowering plants to cause weak flowers to be aborted and stronger flower to be strengthened. The application of the plant growth enhancing mixture for such purpose need not be in conjunction with a nitrogen fertilizer (i.e., the plant growth enhancing mixture comprising cytokinin and gibberellin, and optionally, minerals except nitrogen).

### Example 11

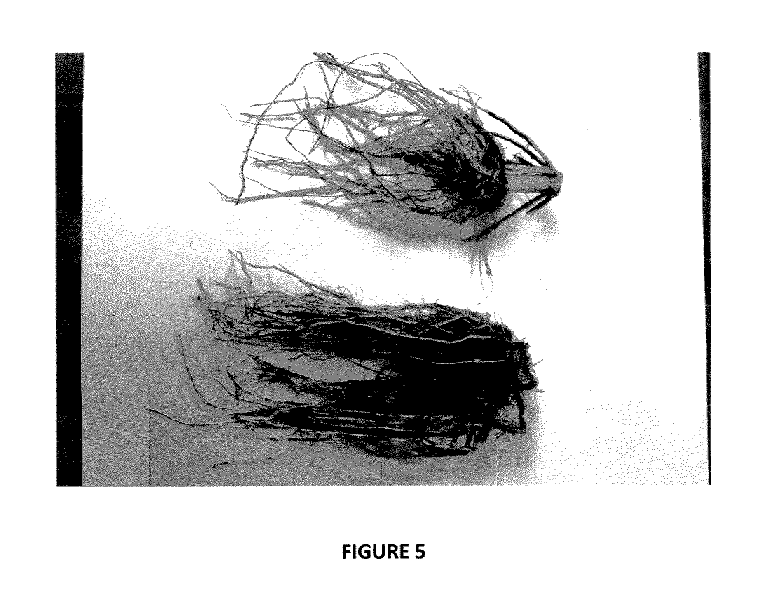

Another feature of the invention is that the plant growth enhancing mixture may be used to strengthen growth of corn plant roots (FIG. 5). The roots on the top of the image are from the untreated corn plant while those at the bottom of the image are from treatment with the mixture at the rate of 4 ounces per acre, applied as an in furrow treatment over the seed at sowing time, just before closure of the open furrow into which the seed is dropped along with the liquid mixture, before closure (burial) of seed and mixture with soil from the sides of the furrow. Roots of the treated plants grew much deeper in to the soil and therefore have a distinct advantage over the untreated plant roots both for garnering more nutrients but also water at deeper soil depths under water deficit conditions.

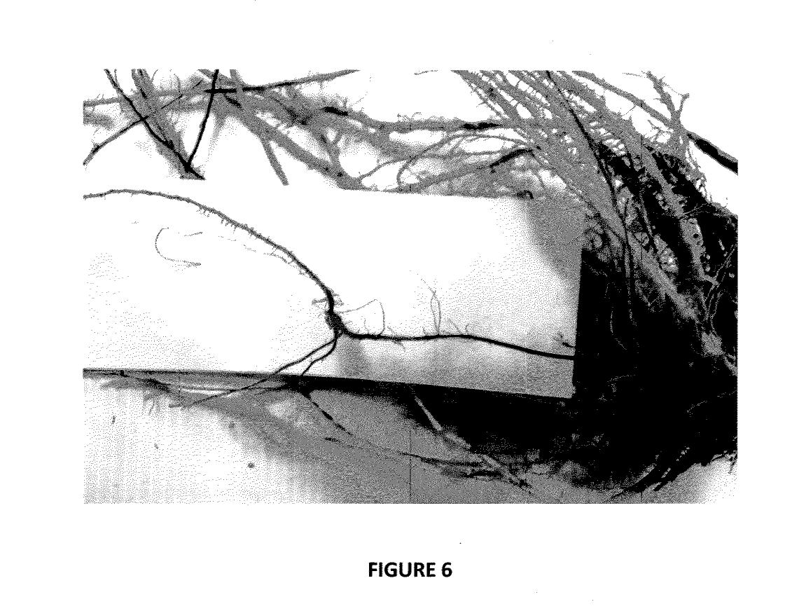

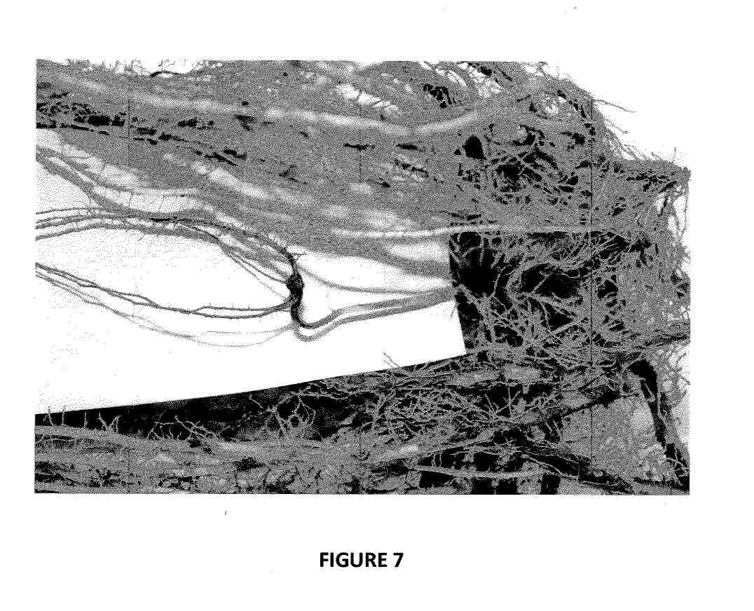

Not only do the roots from the treated plants grow deeper and therefore into lower soil areas, which provides the of extra nutrients and extra water under various forms of drought, but the roots remain actively growing throughout the growing season of the crop. For example, the radicle roots (the roots that are first formed from the seed) from the untreated plants are very dark, indicating essentially a dead root system (FIG. 6). Moreover the radicle roots are rather thin and spindly, and therefore less active in transporting water and nutrients to the top portions of the crop plant. In contrast, as shown in FIG. 7, note how light in color the mesocotyl, above the radicle root system, is, even well into completion of the growth of the crop. Not only is the color lighter, indicating active growth, but the “piping system” for transport of substrates is thicker and shorter, indicating a more functional transport system for water and nutrients. The “bulges” on the radicle roots from both plants in FIGS. 6 and 7 are the remains of the seeds.

Another parameter of the treated plants is that the fresh weights of the roots of the treated plants (137 grams) are much more developed than those of the untreated plants (60 grams) for n=5, with a statistically very significant difference of p<0.01.

Another parameter of the treatment mixture on plant growth is that the circumference of the stalk of the treated plant (7.96 cm) is statistically very significantly different (p<0.01) than the circumference of the untreated plant (6.52 cm).

Another parameter of the treatment mixture on crop plant growth is that the weight of the ear, i.e., the “cob,” and seeds of the treated plant (142.2 grams) is statistically very significantly different (p<0.01) from the untreated plant (89.4 grams).

Another parameter of the treatment mixture on crop plant growth is that the number of rows of seeds on the ear of the treated plants (14.4) is statistically very significantly different (p<0.01) from the untreated plant (12.8).

Another parameter of the treatment mixture on ear growth of the treated crop plant is a greater diameter (11.68 cm), with statistically very significant difference (p<0.01) contrasted to the untreated plant (10.1 cm).

### Example 12

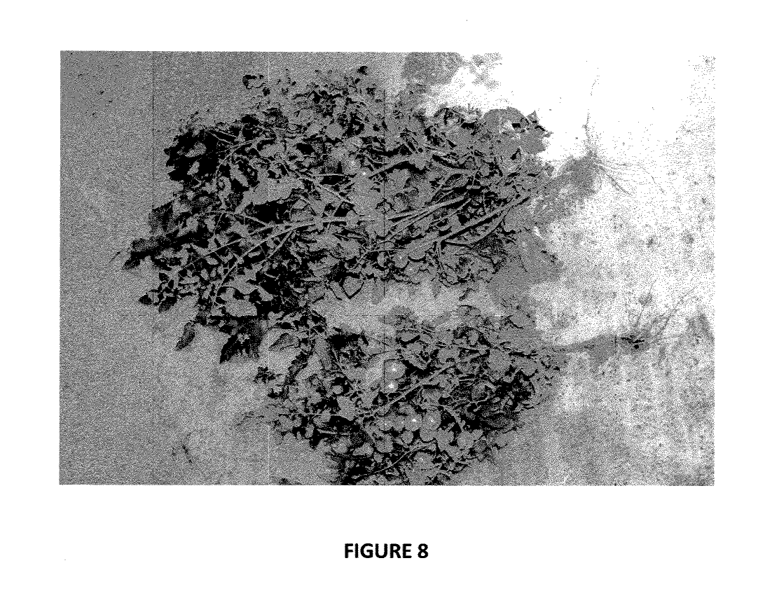

Another feature of the invention is that the plant growth enhancing mixture may be used to strengthen growth of dicot plants such as pepper or tomato (FIG. 8). In this image, the untreated plant (n=5), at the bottom of the image, has a fresh weight of 4.2 pounds. In contrasted the treated plant at the top of the image has a very significantly (p<0.01) higher fresh weight (9.6 pounds).

Another parameter of the treatment mixture on tomato crop plant growth is the number of tomatoes per plant. There were 67 tomatoes per plant on the untreated plants, compared to a very statistically significant increase (p=<0.01) for the treated plants of 166 tomatoes per plant (n=5).

Another parameter of the treatment mixture on tomato crop plant growth is the weight of the tomatoes per plant. The weight of the untreated plant fruit was 3.7 pounds per plant, whereas the very statistically higher (p<0.01) fruit weight for the treated plant was 11.9 grams per plant.

Another parameter of the treatment mixture on tomato crop plant growth is the increased number of branches (see FIG. 8).

To verify this universality of increase in branching for dicotyledon plants, a pepper experiment transplanted and treated in the same manner and on the same dates as the tomato experiment, was also done in Texas. The number of branches for the untreated plant was 5.75 branches per plant (the higher number of branches implies a potentially higher yields as with the tomato plant) while the number of branches for the treated plant (7.55) was very statistically significantly greater (p<0.01) then the untreated control plant.

The Abstract of the disclosure is written solely for providing the United States Patent and Trademark Office and the public at large with a means by which to determine quickly from a cursory inspection the nature and gist of the technical disclosure, and it represents one preferred implementation and is not indicative of the nature of the invention as a whole.

While some implementations of the invention have been illustrated in detail, the invention is not limited to the implementations shown; modifications and adaptations of the disclosed implementations may occur to those skilled in the art. Such modifications and adaptations are in the spirit and scope of the invention as set forth in the claims hereinafter:

What is claimed is:

1. A plant growth enhancing mixture comprising,
a plurality of plant hormones including at least a cytokinin and a gibberellin,
at least one mineral selected from the group consisting of zinc, calcium and boron, and
a nitrogen compound in an amount to apply 50 to 400 lbs. of nitrogen per acre when said nitrogen compound is applied to growing plants.

2. The plant growth enhancing mixture of claim 1 wherein,
said cytokinin is between about 0.003 weight percent and about 0.3 weight percent and said gibberellin is between about 0.1 weight percent and about 10 weight percent.

3. The plant growth enhancing mixture of claim 1 wherein,
said cytokinin is between about 0.0015 weight percent and about 0.15 weight percent and said gibberellin is between about 0.5 weight percent and about 5 weight percent.

4. The plant growth enhancing mixture of claim 1 wherein,
said nitrogen compound is a blend of urea and ammonium nitrate.

5. The plant growth enhancing mixture of claim 1 wherein,
said amount of said nitrogen compound is sufficient to apply 100 to 300 lbs. of nitrogen per acre when said nitrogen compound is applied to said growing plants.

6. The plant growth enhancing mixture of claim 1 wherein,
said mineral is calcium and is applied to plants at a rate of 10 to 100 lbs. per acre.

7. The plant growth enhancing mixture of claim 1 wherein,
said mineral is boron and is applied to plant at a rate of 0.25 to 2 lbs. per acre.

8. A method of enhancing the growth of plant tissues, comprising the steps of,
readying for application to tissues of a plant, or to the soil in which said plant is growing, a plurality of plant hormones including a cytokinin and a gibberellin, and a nitrogen compound in a sufficient amount to apply 50 to 400 lbs. N per acre when applied and
applying said plurality of plant hormones and said nitrogen compound to said tissues of said plant, or to the soil in which said plant is growing, at a time between said plant's seedling and flowering growth stages and in an amount effective to enhance the growth of said tissues of said plant.

9. The method of claim 8 further comprising the step of,
readying for application to tissues of said plant, or to the soil in which said plant is growing, a mineral selected from the group consisting of zinc, calcium and boron, and
applying said mineral to said tissues of said plant, or to the soil in which said plant is growing, at a time between said plant's seedling and flowering growth stages.

10. The method of claim 8 wherein,
said step of applying is performed by injecting said plurality of plant hormones and said nitrogen compound into soil in which said tissues of said plant are growing.

11. The method of claim 8 wherein,
said step of applying said plurality of plant hormones and said nitrogen compound are performed through irrigation.

12. The method of claim 8 wherein,
said step of applying said plurality of plant hormones is performed such that said cytokinin is applied at a concentration of between about 0.003 weight percent and about 0.3 weight percent and said gibberellin is applied at a concentration of between about 0.1 weight percent and about 10 weight percent.

13. The method of claim 9 wherein,
said mineral is calcium and said step of applying said mineral is performed at a rate of 10 to 100 lbs. per acre.

14. The method of claim 9 wherein,
said mineral is boron and said step of applying said mineral is performed at a rate of 0.25 to 2 lbs. per acre.

15. The method of claim 9 wherein,
said plurality of hormones, said mineral and said nitrogen compound are blended prior to application to plants.

16. The method of claim 9 wherein,
said plurality of hormones, said mineral and said nitrogen compound are applied concurrently to plants.

17. The method of claim 9 wherein,
said step of applying is performed such that said plurality of plant hormones, said mineral and said nitrogen compound are not all applied at the same time.

18. A method of enhancing the resistance of crop plants to disease comprising the steps of,
readying for application to tissues of a plant, or to the soil in which said plant is growing, a plurality of plant hormones including a cytokinin and a gibberellin, and a nitrogen compound in a sufficient amount to apply 50 to 400 lbs. nitrogen per acre when applied and
applying said plurality of plant hormones and said nitrogen compound to said tissues of said plant, or to the soil in which said plant is growing, at a time between said plant's seedling and flowering growth stages and in an amount effective to enhance the resistance of said tissues of said plant to disease.

19. The method of claim 18 further comprising the step of,
readying for application to tissues of said plant, or to the soil in which said plant is growing, a mineral selected from the group consisting of zinc, calcium and boron, and
applying said mineral to said tissues of said plant, or to the soil in which said plant is growing, at a time between said plant's seedling and flowering growth stages.

20. The method of claim 18 wherein,
said step of applying is performed by injecting said plurality of plant hormones and said nitrogen compound into soil in which said tissues of said plant are growing.

21. The method of claim 18 wherein,
said step of applying said plurality of plant hormones and said nitrogen compound are performed through irrigation.

22. The method of claim 18 wherein,
said step of applying said plurality of plant hormones is performed such that said cytokinin is applied at a concentration of between about 0.003 weight percent and about 0.3 weight percent and said gibberellin is applied at a concentration of between about 0.1 weight percent and about 10 weight percent.

23. The method of claim 19 wherein,
said mineral is calcium and said step of applying said mineral is performed at a rate of 10 to 100 lbs. per acre.

24. The method of claim 19 wherein,
said mineral is boron and said step of applying said mineral is performed at a rate of 0.25 to 2 lbs. per acre.

25. The method of claim 19 wherein,
said plurality of hormones, said mineral and said nitrogen compound are blended prior to application to plants.

26. The method of claim 19 wherein,
said plurality of hormones, said mineral and said nitrogen compound are applied concurrently to plants.

27. The method of claim 19 wherein,
said step of applying is performed such that said plurality of plant hormones, said mineral and said nitrogen compound are not all applied at the same time.

28. A method of treating plants with a plant growth enhancing mixture to strengthen weak flowers and normally strong flowers thereby enhancing said plants, said method comprising the steps of,
readying for application to tissues of a plant, or to the soil in which said plant is growing, a plurality of plant hormones including a cytokinin and a gibberellin, and a nitrogen compound in a sufficient amount to apply 50 to 400 lbs. N per acre when applied, and
applying said plurality of plant hormones and said nitrogen compound to said tissues of said plant, or to the soil in which said plant is growing, at a time during said plant's flowering stage of development.

29. The method of claim 28 further comprising the step of,
readying for application to tissues of said plant, or to the soil in which said plant is growing, a mineral selected from the group consisting of zinc, calcium and boron, and
applying said mineral to said tissues of said plant, or to the soil in which said plant is growing, at a time during said plant's flowering stage of development.

30. A method of farming comprising the steps of,
readying for application to tissues of a plant, or to the soil in which said plant is growing, a plurality of plant hormones including at least a cytokinin and a gibberellin, and a first nitrogen compound in a sufficient amount to apply 10 to 400 lbs. N per acre when applied and
applying said plurality of plant hormones and said first nitrogen compound to said tissues of said plant, or to the soil in which said plant is growing, at a time between said plant's seedling and flowering growth stages and in an amount effective to enhance the growth of said tissues of said plant.

31. The method of claim 30 further comprising the step of,
readying for application to tissues of said plant, or to the soil in which said plant is growing, a mineral selected from the group consisting of zinc, calcium and boron, and
applying said mineral to said tissues of said plant, or to the soil in which said plant is growing, at a time during said plant's flowering stage of development.

32. The method of claim 30 further comprising the step of,
readying for another application to tissues of said plant, or to the soil in which said plant is growing, a second nitrogen compound in a sufficient amount to apply 10 to 400 lbs. N per acre when applied and
applying said another application of said second nitrogen compound to said tissues of said plant, or to the soil in which said plant is growing, at a time prior to said flowering growth stage and in an amount effective to enhance the growth of said tissues of said plant.

33. The method of claim 30 further comprising the step of,
readying for another application to tissues of said plant, or to the soil in which said plant is growing, a second nitrogen compound in a sufficient amount to apply 10 to 400 lbs. N per acre when applied and
applying said another application of said second nitrogen compound to said tissues of said plant, or to the soil in which said plant is growing, at a time between said seedling growth stage and said application of said plurality of said plant hormones and in an amount effective to enhance the growth of said tissues of said plant.

34. The method of claim 32 wherein,
said first nitrogen compound and said second nitrogen compound are a same type of nitrogen compound.

35. The method of claim 33 wherein,
said first nitrogen compound and said second nitrogen compound are a same type of nitrogen compound.
